(19) United States
(12) Patent Application Publication
(10) Pub. No.: US 2026/0214014 A1
(43) Pub. Date: Jul. 23, 2026

(54) Transmission channel representation

(71) Applicant: Telefonaktiebolaget LM Ericsson (publ), Stockholm (SE)

(72) Inventors: Jakob STIGENBERG, Stockholm (SE); Martin HESSLER, LINKÖPING (SE)

(21) Appl. No.: 19/137,912

(22) PCT Filed: Dec. 13, 2022
(86) PCT No.: PCT/EP2022/085595

§ 371 Date: Jun. 11, 2025

(51) Int. Cl. H04L 41/14

(52) U.S. Cl. CPC H04L 41/145

(57) ABSTRACT

A method of providing a representation of a transmission channel in a wireless communications network is presented. The method includes obtaining a set of input propagation properties for the transmission channel and splitting the set of input propagation properties into a plurality of input propagation property subsets. The method further includes providing each of the input propagation property subsets as input to a respective modelling circuit, wherein all respective modelling circuits are identical and obtaining, from the respective modelling circuit, a plurality of representation subsets. The method further includes aggregating the plurality of representation subsets, thereby providing the representation of the transmission channel.

### TECHNICAL FIELD

The present disclosure relates to communications systems and more precisely to methods and systems for representing a transmission channel.

More specifically, the present disclosure presents methods, channel representation provisioning systems, transmission success metric estimating system, corresponding communication networks and related computer program products.

### BACKGROUND

Accurate estimations of transmission channels are key in many stages of operation, planning and optimization of communications networks. However, with increased utilization communications networks, more advanced spectrum access and sharing techniques, the transmission channels are getting increasingly complex. The number of possible paths for one single transmission in a wireless network are almost unlimited and if interfering signals from other communication devices and technologies are considered, the complexity of representing a model a transmission channel is clear.

### SUMMARY

It is in view of the above considerations and others that the various embodiments of this disclosure have been made. The inventors of the aspects and embodiments described throughout this disclosure have realized that there is room for improvements in the existing art described above in the background. The present disclosure therefor recognizes the fact that there is a need for alternatives to (e.g. improvement of) the existing art.

It is an object of some embodiments to solve, mitigate, alleviate, or eliminate at least some of the above or other disadvantages.

An object of the present disclosure is to provide a new type of architecture for providing a representation of a transmission channel which is improved over prior art and which eliminates or at least mitigates the drawbacks discussed above. More specifically, an object of the invention is to provide a method for providing a representation of a transmission channel that requires less computer resources in execution and that may be scaled without significant increase in computing complexity. These objects are achieved by the technique set forth in the appended independent claims with preferred embodiments defined in the dependent claims related thereto.

In a first aspect, a method of providing a representation of a transmission channel in a wireless communications network is presented. The method comprises obtaining a set of input propagation properties for the transmission channel and splitting the set of input propagation properties into a plurality of input propagation property subsets. Further to this, the method comprises providing each of the input propagation property subsets as input to a respective modelling circuit. All respective modelling circuits are identical. The method further comprises obtaining, from the respective modelling circuit, a plurality of representation subsets and aggregating the plurality of representation subsets, thereby providing the representation of the transmission channel.

In one variant, the plurality of input propagation property subsets comprises a first propagation property subset and a second propagation property subset. The first subset of propagation properties are properties of one or more serving propagation paths of the transmission channel, and the second subset of properties are properties of one or more interfering propagation paths of the transmission channel.

In one variant, the plurality of input propagation property subsets comprises a first propagation property subset comprising properties of one or more serving propagation paths of the transmission channel and a plurality of second sets of propagation properties.

In one variant, each second set of input propagation properties are input propagation properties of interfering propagation paths of the transmission channel of a respective base station of the wireless communications network.

In one variant, aggregating the plurality of representation subsets further comprises appending one or more transmission properties to some or all of the plurality of representation subsets.

In one variant, the transmission properties comprises one or more of a transmission power and/or a master coding scheme, MCS, selection.

In one variant, the modelling circuits are neural networks.

In one variant, the modelling circuits are LSTM-based recurrent neural networks.

In one variant, the neural networks are weight sharing neural networks.

In a second aspect, a method of estimating a transmission success metric of a transmission on a transmission channel is presented. The method comprises obtaining a set of input propagation properties of the transmission channel and obtaining one or more transmission properties of the transmission channel. The method further comprises providing the set of input propagation properties to the method according to the first aspect, thereby obtaining a representation of the transmission channel and further providing the representation of the transmission channel and the one or more transmission properties of the transmission channel to one or more transmission success metric estimators. The one or more transmission success metric estimators being a fully connected neural network. Further to this, the method comprises obtaining, from the one or more transmission success metric estimators, one or more estimated transmission success metric.

In variant, the estimated transmission success metric comprises an estimated transmission success rate.

In one variant, the estimated transmission success metric comprises an estimated bit error rate, BER.

In one variant, the one or more transmission properties comprises a transmission power and/or a master coding scheme, MCS, selection.

In a third aspect, a channel representation provisioning system for providing a representation of a transmission channel is presented. The channel representation provisioning system comprises a resolver circuit configured to obtain a set of input propagation properties for the transmission channel and split the set of input propagation properties into a plurality of input propagation property subsets. The system further comprises a plurality of modelling circuits, each configured to obtain a respective input propagation property subsets, identical and provide a respective representation subsets, wherein all modelling circuits are equal, and an aggregation circuit configured to aggregate the plurality of representation subsets and provide the representation of the transmission channel.

In one variant, the channel representation provisioning system is configured to perform the method according to the first aspect.

In a fourth aspect, a transmission success metric estimating system for estimating a transmission success metric of a transmission on a transmission channel is presented. The transmission success metric estimating system comprises a channel representation provisioning system according to the third aspect and one or more transmission success metric estimators configured to obtain the representation of the transmission channel from the channel representation provisioning system and provide one or more estimated transmission success metric based on one or more transmission properties and the one or more estimated transmission success metric.

In one variant, the transmission success metric estimating system is further configured to perform the method the second aspect.

In a fifth aspect, a communications network comprising at least one transmission success metric estimating system the fourth aspect is presented.

In one variant, the communications network is a physical wireless communications network.

In one variant, the communications network is a digital twin of a physical wireless communications network.

In a sixth aspect, a computer program product is presented. The computer program product comprises a non-transitory computer readable medium, having thereon a computer program comprising program instructions. The computer program is loadable into a data processing unit and configured to cause execution of the method according to the first aspect when the computer program is run by the data processing unit.

In a seventh aspect, a computer program product is presented. The computer program product comprises a non-transitory computer readable medium, having thereon a computer program comprising program instructions. The computer program is loadable into a data processing unit and configured to cause execution of the method according to the second aspect when the computer program is run by the data processing unit.

### BRIEF DESCRIPTION OF THE DRAWINGS

These and other aspects, features and advantages will be apparent and elucidated from the following description of various embodiments; references being made to the appended diagrammatical drawings which illustrate non-limiting examples of how the concept can be reduced into practice.

FIG. 1 is a schematic view of a communications network according to some embodiments of the present disclosure;

FIG. 2 is a block diagram of a neural network for modelling a transmission success metric;

FIGS. 3a and 3b are block diagrams of channel representation provisioning systems according to some embodiments of the present disclosure;

FIGS. 4a and 4b are block diagrams of transmission success metric estimating systems according to some embodiments of the present disclosure;

FIG. 5 is a block diagram of a method for providing a representation of a transmission channel according to some embodiments of the present disclosure;

FIG. 6 is a block diagram of a method for estimating a transmission success metric according to some embodiments of the present disclosure;

FIG. 7 is a block diagram of a communications network according to some embodiments of the present disclosure;

FIG. 8 is a block diagram of a communications network according to some embodiments of the present disclosure;

FIG. 9 is a schematic view of a computer program product according to some embodiments of the present disclosure;

FIG. 10a is a schematic view of a computer program being loaded onto a communications network according to some embodiments of the present disclosure;

FIG. 10b is a schematic view of a computer program being loaded onto a wireless device according to some embodiments of the present disclosure; and

FIG. 10c is a schematic view of a computer program being loaded onto a radio base station according to some embodiments of the present disclosure.

### DETAILED DESCRIPTION

Hereinafter, certain embodiments will be described more fully with reference to the accompanying drawings. The invention described throughout this disclosure may, however, be embodied in many different forms and should not be construed as limited to the embodiments set forth herein; rather, these embodiments are provided by way of example so that this disclosure will be thorough and complete, and will fully convey the scope of the invention, such as it is defined in the appended claims, to those skilled in the art.

The term “coupled” is defined as connected, although not necessarily directly, and not necessarily mechanically. Two or more items that are “coupled” may be integral with each other. The terms “a” and “an” are defined as one or more unless this disclosure explicitly requires otherwise. The terms “substantially”, “approximately”, and “about” are defined as largely, but not necessarily wholly what is specified, as understood by a person of ordinary skill in the art. The terms “comprise” (and any form thereof, such as “comprises” and “comprising”), “have” (and any form thereof, such as “has” and “having”, “include” (and any form thereof, such as “includes” and “including”) and “contain” (and any form thereof, such as “contains” and “containing”) are open-ended linking verbs. As a result, a method that “comprises”, “has”, “includes” or “contains” one or more steps possesses those one or more steps, but is not limited to possessing only those one or more steps.

In the present disclosure, terms like “circuit”, “device”, “model” (and any forms thereof) may refer equally to physical devices or virtual, software implemented devices or functions.

In the digital world strong advancement in capabilities of hardware has opened new opportunities that seemed impossible only a few years ago. In multiple industries, digital twin technology has enabled training of self-driving cars in virtual reality (VR), testing products in combination of VR and the real world, i.e. augmented reality (AR) are only a few examples. A digital twin is a digital representation of a product, system, or process intended or available in the real-world.

Digital twins are utilized within a vast array of technologies such as healthcare, automotive, construction etc. However, in radio technology, one step missing in order to provide a digital twin of a real radio network, is to provide a virtual representation of the radio environment. Having a virtual radio environment that acts, or substantially acts, as a real radio environment is not only a scientific problem in electromagnetic theory, but also in providing of parallelizable algorithms and data structures that allow for maximizing hardware utilization.

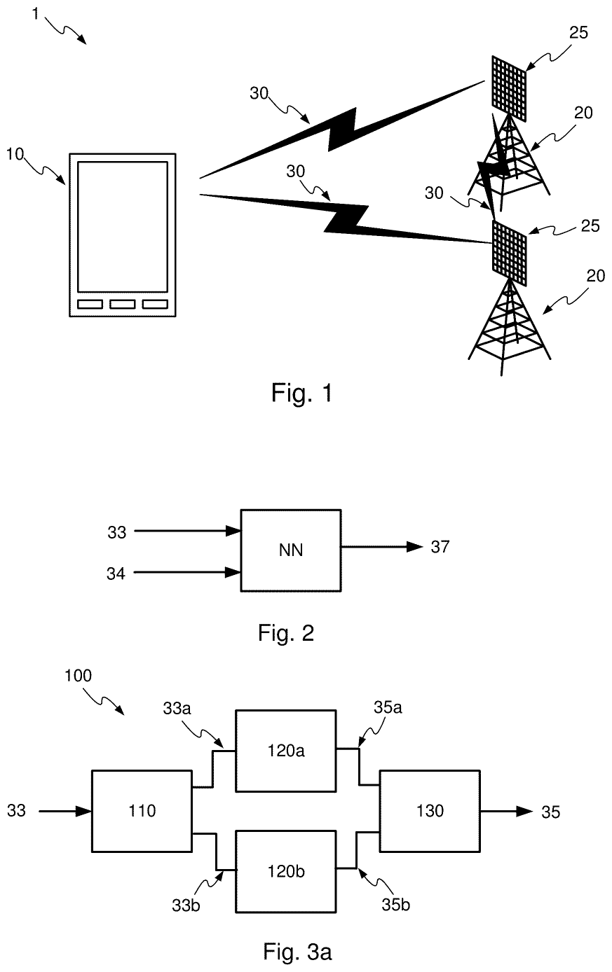

In FIG. 1, an exemplary communications network 1 is shown wherein embodiments of the present invention may be employed. The communications network 1 may be a physical real-world network or a virtual computer-implemented network. A wireless communication device 10, or wireless device 10 for short of the communications network 1 is in wireless communication with one or more radio base stations 20 of the communications network 1. The wireless device 10 may be, what is generally referred to as, a user equipment (UE). The wireless device 10 is depicted in FIG. 1 as a mobile phone, but may be any kind of device with cellular communication capabilities, such as a tablet or laptop computer, machine-type communication (MTC) device, or similar. Furthermore, the communications network 1 may, as seen in FIG. 1, be a cellular communications system 1. However, embodiments of the present invention may be applicable in other types of cellular or non-cellular systems as well, such as, but not limited to, WiFi systems.

The radio base stations 20 and wireless device 10 are examples of what in this disclosure is generically referred to as communication apparatuses. Embodiments are described below in the context of a communication apparatus in the form of the radio base station 20 or wireless device 10. However, other types of communication apparatuses can be considered as well, such as, but not limited to, a WiFi access point or WiFi enabled device etc. In FIG. 1, the communications network 1 is shown comprising two base stations 20 although any number of base stations 20 may be considered. Each base station 20 is provided with an antenna array 25 configured for beamforming in uplink and/or downlink. In addition, the wireless device 10 may be provided with an antenna array (not shown) configured for beamforming in uplink and/or downlink. As is well known in the art, an antenna array 25 comprises a plurality of antenna elements which may be excited by mutually phase shifted (time delayed) instances of a signal in order to control a direction of a transmission (or reception). This concept is generally described as beamforming. To exemplify, one signal may be transmitted or received in one or more beams. Either the signal may originate from more than one source, each source transmitting one beam, or a plurality of beams may arise from e.g. multi-path propagation etc. Regardless, the signal will be transferred across a transmission channel 30. The transmission channel 30 is a combination of all transmission paths of the signal including any paths that may carry interfering signals.

A transmission channel 30 may be described by a plurality of propagation properties 31 (see FIG. 2). These propagation properties 31 may be any suitable parameter and may comprise parts of, or (substantially) complete parameters describing each, or either of, a transmitting device and a receiving device (e.g. a transmitting or receiving wireless apparatus). Propagation properties 31, in this context, may be any set of information that contributes to the overall radio environment. To exemplify, in a digital twin of a radio network, these may be the set of propagation taps. In a live network, these may be measurements from a live NR/LTE network, such as RSRP, or UL SRS.

Modelling a transmission channel 30 consequently requires vast amount of data. Each possible path is preferably accurately described and also considering interfering transmissions, greatly increases the complexity of providing an, to a degree, accurate representation of a transmission channel 30 and its propagation properties 31.

The inventors behind the present disclosure have identified the above shortcomings of the technology present and the teachings presented herein stem from these problems. The teachings presented herein are applicable both on physical real-life radio environments where channel modelling and propagation analysis are key when performing e.g., precoding etc. and within digital twin technology. Currently, models are based on statistical radio channel modes e.g., 3^{rd} Generation Partnership Program (3GPP) models such as 5G spatial channel model (SCM). Consequently, the ability to accurately and rapidly provide e.g. a channel model or a transmission success rate is a significant advantage and will greatly improve throughput, reliability etc. of a communications networks 1. Accurate models (representations) reduces a risk of interference between transmission channels 30. The end effect is that a spectrum utilization may be increased and the power consumption of communications networks may be decreased due to e.g., decreased transmission powers.

Currently, see FIG. 2, it may be possible to train and provide a neural network NN, e.g., a model NN, capable of modelling high level metrics such as a transmission success metric 37 of a transmission channel 30 in a communications network 1. A transmission success metric 37, may be exemplified by, but not limited to, a bit error rate (BER), transmission success rate, a signal to noise ratio (SNR), Reference signal received power (RSRP), block error rate (BLER) etc. A set of input propagation properties 33 are provided to the neural network NN, in conjunction with transmission properties 34. From this, the transmission success metric 37 is to be provided. The transmission properties 34 may be, but are not limited to, a power of the transmitted signal, a master coding scheme (MCS) etc. The set of input propagation properties 33 may comprise data indicative one or more of an angle of arrival, a time of arrival, a beam direction, one or more interfering transmissions, a location of a receiver, a location of a transmitter etc. The set of input propagation properties 33 does generally not comprise details of actual propagation of the transmission channel 30, but rather the input constraints, or conditions, for determining the actual propagation properties of the transmission channel 30.

However, training such a neural network NN requires vast amounts of data due to, as explained above, the large degree of freedom of parameters involved. A transmission channel 30 may be subject to any number of interfering channels and the complexity will rapidly increase. Further transmission properties 34 of both a wanted signal and any interferer will affect the transmission success metric 37. Consequently, in order to capture the large freedom of parameters, models themselves need in turn to be parametrized by a large number of parameters, increasing model complexity, training time, and spatial complexity.

The inventors have realized that, by imposing a structure on a learnt representation, the imposed structure allows for a divide-and-conquer approach when processing input of varying size. The structure is suitable for being executed in a parallel fashion which reduces complexity and therefore training time, model size, and inference time.

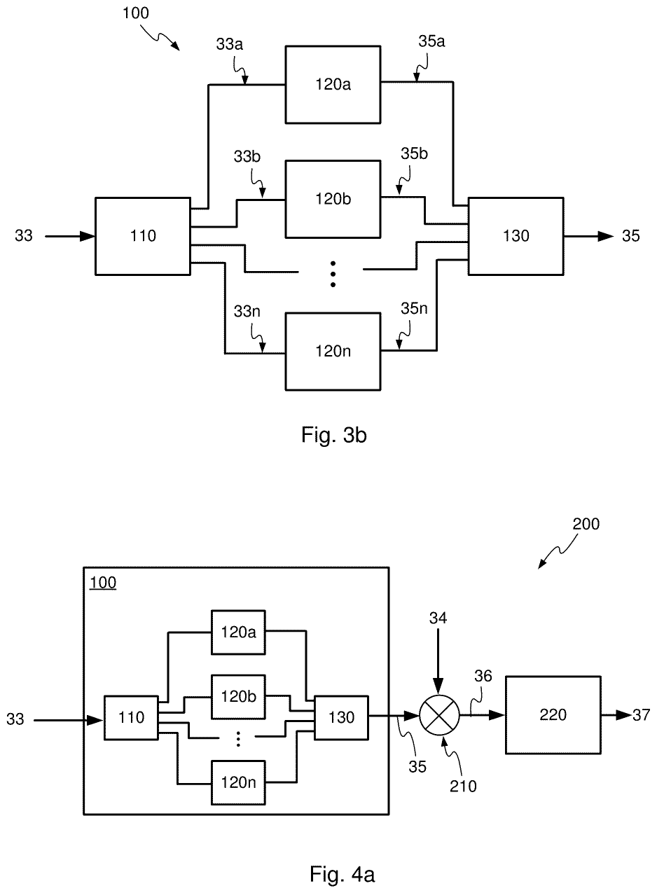

In FIG. 3a, a channel representation provisioning system 100 for providing a representation 35 of a transmission channel 30 is shown. The representation 35 may e.g. comprise propagation properties 31 detailing (substantially) all or all relevant wanted and interfering paths constituting the transmission channel 30. The set of input propagation properties 33 are provided to a resolver circuit 110. The resolver circuit 110 is configured to split the input propagation properties 33 into at least two input propagation property subsets 33a, 33b. Each of the input propagation property subsets 33a, 33b is provided to a respective modelling circuit 120a, 120b. Each modelling circuit 120a, 120b is configured to provide a representation subset 35a, 35b associated with a respective input propagation property subset 33a, 33b. The representation subset 35a, 35b may e.g. comprise propagation properties of paths resulting from the input propagation property subset 33a, 33b. The representation subsets 35a, 35b are provided to an aggregation circuit 130 configured to combine the representation subsets 35a, 35b and provide the representation 35 of the transmission channel 30.

The channel representation provisioning system 100 of FIG. 3a is configured to split and process the input propagation properties 33 in two. However, this is in but one exemplary embodiment and shown in FIG. 3b, the channel representation provisioning system 100 may be configured to split the input propagation properties 33 into a plurality n of input propagation property subsets 33a, 33b, . . . , 33n. Each of the plurality n of input propagation property subsets 33a, 33b, . . . , 33n is provided to a respective modelling circuit 120a, 120b, . . . , 120n. Each modelling circuit 120a, 120b, . . . , 120n is configured to provide a representation subset 35a, 35b, . . . , 35n based on its associated input propagation property subset 33a, 33b, . . . , 33n.

The plurality of representation subset 35a, 35b, . . . , 35n are combined by the aggregation circuit 130 to provide the representation 35 of the transmission channel 30. A number of input propagation property subsets 33a, 33b, . . . , 33n match a number of modelling circuit 120a, 120b, . . . , 120n and a number of representation subset 35a, 35b, . . . , 35n.

The resolver circuit 110 may configured to split the input propagation properties 33 in any suitable way. In an advantageous example, the resolver circuit 110 is configured to split the input propagation properties 33 into wanted input propagation properties 33a, 33b, . . . , 33n and interfering input propagation properties 33a, 33b, . . . , 33n. This is beneficial as the interfering input propagation properties 33a, 33b, . . . , 33n will then be modelled separately and aggregation of the representation subsets 33a, 33b, . . . , 33n is simplified. If more than one base station 20 affect the transmission channel 30, the resolver circuit 110 may configured to split the input propagation properties 33 in subsets 33a, 33b, . . . , 33n based on originating (or terminating) base station 20. The split may further be combinations of propagation properties split with regards to signal source (base station 20) and with regards to wanted signals and interfering signals.

The modelling circuits 120a, 120b, . . . , 120n may be any suitable model configured to provide representation subset 35a, 35b, . . . , 35n based on input propagation property subsets 33a, 33b, . . . , 33n. Advantageously, the modelling circuits 120a, 120b, . . . , 120n are neural networks configured (trained) to provide representation subset 35a, 35b, . . . , 35n based on input propagation property subsets 33a, 33b, . . . , 33n. The modelling circuits 120a, 120b, . . . , 120n may be corresponding modelling circuits 120a, 120b, . . . , 120n that would have been utilized to provide the representation 35 of the transmission channel 30 directly from the input propagation properties 33, i.e. without any resolver circuit 110 or aggregation circuit 130. Advantageously, the modelling circuits 120a, 120b, . . . , 120n are long short-term memory (LSTM) based neural networks. This is beneficial as LSTM based neural networks are able to handle entire sequences of data, as opposed to general recurrent neural networks (RNN) which only processes one data set at a time.

The modelling circuits 120a, 120b, . . . , 120n are advantageously similar, and more advantageously identical. Identical modelling circuits 120a, 120b, . . . , 120n may be provided by configuring the modelling circuits 120a, 120b, . . . , 120n as weight sharing modelling circuits 120a, 120b, . . . , 120n.

The aggregation circuit 130 aggregates the representation subset 35a, 35b, . . . , 35n into a representation 35 of the transmission channel 30. This may be performed by, but not limited to, vector concatenation or summation. The aggregation circuit 130 may be configured in any suitable way and its configuration may depend on what further processing is intended for the representation 35.

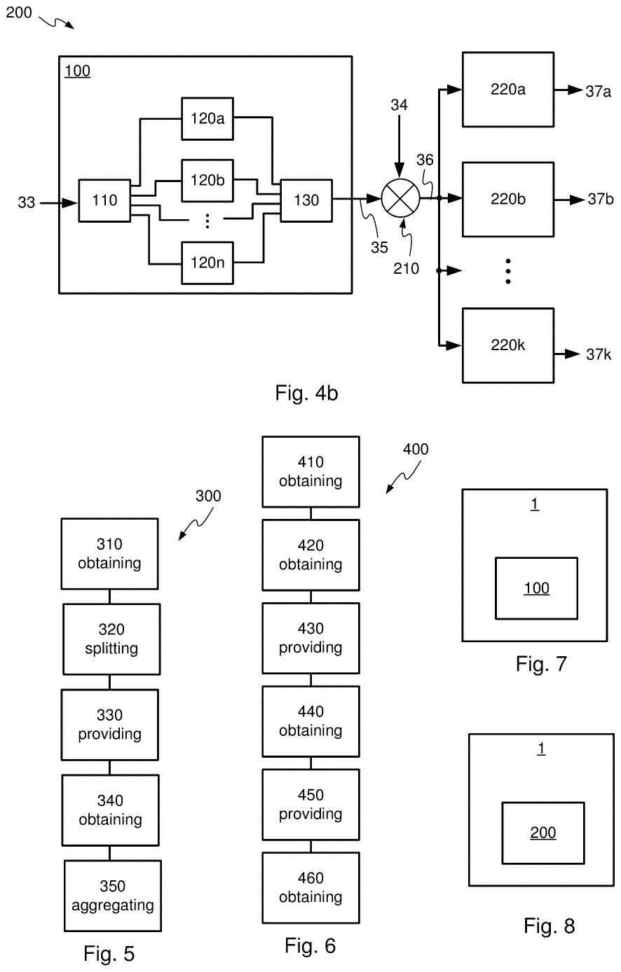

In FIG. 4a, a transmission success metric estimating system 200 for estimating the transmission success metric 37 of a transmission on the transmission channel 30 is shown. The transmission success metric estimating system 200 comprises the channel representation provisioning system 100 according to any example or embodiment presented herein. An output of the channel representation provisioning system 100, i.e. the representation 35 of the transmission channel 30 is provided to a combining circuit 210 that is configured to combine the representation 35 of the transmission channel 30 with transmission properties 34 to provide a transmission specific representation 36. To exemplify, the transmission specific representation 36 may comprise all signal paths relevant for a transmission channel each may be paired with one or more of a respective MCS and/or transmission power of wanted signals or interfering signals, whichever is relevant for the specific path. It should be mentioned that the combining circuit 210, or its corresponding functionality, may be comprised in the aggregation circuit 130 of the channel representation provisioning system 100. If this is the case, the channel representation provisioning system 100 would be configured to provide the transmission specific representation 36 as an output.

The transmission specific representation 36 is provided to a transmission success metric estimator 220 of the transmission success metric estimating system 200. The transmission success metric estimator 220 may be any suitable system, process or model configured to provide the estimated transmission success metric 37 based on the transmission specific representation 36. The transmission success metric estimator 220 is advantageously a fully connected neural network configured to provide the estimated transmission success metric 37 based on the transmission specific representation 36.

In FIG. 4b, a further example of the transmission success metric estimating system 200 for estimating the transmission success metric 37 of a transmission on the transmission channel 30 is shown. This example is similar to the example of FIG. 4a, but with the difference that a plurality of transmission success metric estimators 220a, 220b, . . . , 220k are provided. Each of the transmission success metric estimators 220a, 220b, . . . , 220k is provided with the transmission specific representation 36. The transmission success metric estimators 220a, 220b, . . . , 220k are advantageously configured to provide different estimated transmission success metrics 37 based on the transmission specific representation 36. To exemplify, a first transmission success metric estimators 220a may be configured to estimate a BER based on the transmission specific representation 36. A second transmission success metric estimators 220a may be configured to estimate a SNR based on the transmission specific representation 36. A k:th transmission success metric estimators 220k may be configured to estimate a transmission success rate based on the transmission specific representation 36

Comparing the transmission success metric estimating system 200 of FIGS. 4a-b with the neural network NN of FIG. 2, the transmission success metric estimating system 200 provides a parallelizable and scalable solution significantly increasing efficiency and decreasing computational complexity.

As a non-limiting exemplary embodiment, consider a digital twin of communications network 1 and utilizing the teachings of the present disclosure to provide a transmission success metric 37. Initially, obtain all propagation taps, e.g. signals from specific antenna elements of an antenna array, for a specific wireless device 10. Encode each tap into a vector t∈R^{N}^{_{T}}. Construct a modelling circuit 120, advantageously an LSTM-based recurrent neural network, producing the sequence of outputs r₁, . . . , r_{M}, given the input sequence t₁, . . . , t_{K}. However, ignoring r₁, . . . , r_{K-1}, let r:=rₖ denote the representation of channel propagation taps t₁, . . . , t_{K} This is F.

Now, given a set of taps

$${\{ {t}_{i} \}}_{i = 1}^{M}$$

(the input propagation properties 33), construct two subsets A, B, where A contains all taps modelling a serving base station 20, and B contains all taps of interfering base stations 20, these correspond to two input propagation property subsets 33a, 33b. Using the LSTM-based network, i.e. the modelling circuits 120, compute r_{A}=F(A), r_{B}=F(B) (representation subsets 35a, 35b, . . . , 35n), where F(X) amounts to applying the elements of X into the modelling circuits 120.

Concatenate, by the aggregation circuit 130, the vectors r_{A}, r_{B} together with other relevant transmission properties 34 such as MCS selection and transmission power. Pass this vector, i.e. the transmission specific representation 36, through a fully connected neural network (G), i.e. the transmission success metric estimator 220, of some depth with one single output neuron. Apply the sigmoid activation function to the output,

$$f ( x ) = \frac{1}{1 + {e}^{- x}} ,$$

achieving a bounded value in (0, 1). Let this value denote the transmission success metric 37, e.g. in the form of a transmission success rate.

In another non-limiting exemplary embodiment, consider a digital twin of communications network 1 and utilizing the teachings of the present disclosure to provide a transmission success metric 37. Corresponding to the previous example, obtain all propagation taps for a specific UE 10. Encode each tap into a vector t∈R^{N}^{_{T}}. Construct an LSTM-based recurrent neural network (the modelling circuits 120), producing the sequence of outputs r₁, . . . , r_{M}, given the input sequence t₁, . . . , t_{K}. However, ignoring r₁, . . . , r_{K-1}, let r:=r_{K} denote the representation of channel propagation taps t₁, . . . , t_{K}. This is F.

Given a set of propagation taps

$${\{ {t}_{i} \}}_{i = 1}^{M}$$

from N cells (the input propagation properties 33), construct, by means of the resolver circuit 110, the sets A₁, . . . , A_{N} (input propagation property subsets 33), where Aᵢ contains all taps originating from cell i. Using the LSTM-based network (the modelling circuits 120), compute r_{A}_{₁}=F(A₁), . . . , r_{A}_{_{N}}=F(A_{N}) (representation subsets 35a, 35b, . . . , 35n), where r_{A}_{ᵢ} denotes the output from passing all elements of Aᵢ through F.

Compute

$${g}_{i} = {\sum }_{j = 1}^{N} ( 2 * 1 \{ j = i \} - 1 ) {r}_{{A}_{j}} ,$$

and pass these through K fully connected networks (G), i.e. transmission success metric estimators 220a, 220b, . . . , 220k, computing N instances of K different desired properties, e.g. RSRP. Note that F is applied to M vectors, independently of N and K. The overall complexity of this algorithm is therefore O(M+NK), instead of O(MNK).

As is well understood by the skilled person after digesting the teachings presented herein, the present disclosure enables training of smaller models, thus reducing training time, reducing spatial complexity, reducing inference time, as well as imposing structure on the latent space. This is beneficial in various perspectives. For example, the learnt representation may be reused in other applications.

To exemplify, consider a scenario with N cells (base stations 20). In order to estimate a specific property, e.g. RSRP or BLER, for all choices of serving cells i=1, 2, . . . , N. Split the set of all channel propagation properties into N subsets, where subset i contains only the propagation properties related to cell i. F is applied to these N sets in parallel, producing outputs f₁, . . . , f_{N}. Next, apply the following aggregation formula, to compute the aggregated representation gᵢ:

$${g}_{i} = {{\sum }^{N}}_{j = 1} ( 2 * 1 \{ j = i \} - 1 ) {f}_{j}$$

where 1{j=i} is 1 if j=i, otherwise 0. In other words, serving cell(s) are added and interfering cells are subtracted from the output gᵢ. Note, that F is applied N times, each time to only a subset of the input. Other methods of training end-to-end require revisiting each data point for all choices of serving cell, i. Hence, our innovation reduces time complexity, in this scenario, from O(M²) to O(M), where M denotes the input size.

In FIG. 5, and based on the teachings presented herein, specifically in reference to the channel representation provisioning system 100 of FIG. 3a-b, a method 300 of providing a representation of a transmission channel 30 in the wireless communications network 1 is shown. The method 300 may, wholly or in part, be performed, or caused, by the channel representation provisioning system 100 presented herein. The method 300 may, wholly or in part, be performed, or caused, by the wireless communications network 1 presented herein.

The method 300 comprises obtaining 310 a set of input propagation properties 33 for the transmission channel 30. The input propagation properties 33 may be any input propagation properties 33 as presented herein.

The method 300 further comprises splitting 320 the set of input propagation properties 33 into a plurality of input propagation property subsets 33a, 33b, . . . , 33n. The splitting 320 may be performed, or caused, by any suitable process, device or circuit, e.g. the resolver circuit 110 as presented herein.

In some embodiments, the plurality of input propagation property subsets 33a, 33b, . . . , 33n comprises a first propagation property subset 33a and a second propagation property subset 33b. The first subset of propagation properties 33a may be properties of one or more serving propagation paths of the transmission channel 30. The second subset of properties 33b may be properties of one or more interfering propagation paths of the transmission channel 30. In some embodiments, the interfering propagation paths of the transmission channel 30 are split into a plurality of input propagation property subsets 33a, 33b, . . . , 33n.

Each of the input propagation property subsets 33a, 33b, . . . , 33n may be provided 330 as input to a respective modelling circuit 120a, 120b, . . . , 120n. From this, a plurality of representation subsets 35a, 35b, . . . , 35n are obtained 340. Advantageously, all respective modelling circuits 120a, 120b, . . . , 120n are identical.

The method 300 further comprises aggregating 350 the plurality of representation subsets 35a, 35b, . . . , 35n and thereby providing the representation 35 of the transmission channel 30. In some embodiments, aggregating 350 the plurality of representation subsets 35a, 35b, . . . , 35n further comprises appending one or more transmission properties 34 to some or all of the plurality of representation subsets 35a, 35b, . . . , 35n.

In FIG. 6, and based on the teachings presented herein, specifically in reference to the transmission success metric estimating system 200 of FIGS. 2a-b, a method 400 of estimating a transmission success metric 37a, 37n, . . . , 37k of a transmission on a transmission channel 30 in the wireless communications network 1 is shown. The method 400 may, wholly or in part, be performed, or caused, by the transmission success metric estimating system 200 presented herein. The method 400 may, wholly or in part, be performed, or caused, by the wireless communications network 1 presented herein.

The method 400 comprises obtaining 410 a set of input propagation properties 33 of the transmission channel 30 and obtaining 420 one or more transmission properties 34 of the transmission channel 30.

The method 400 further comprises providing 430 the set of input propagation properties 33 to the method 300 of providing a representation of a transmission channel 30 presented with reference to FIG. 5, and thereby obtaining 440 a representation 35 of the transmission channel 30.

The method 400 further comprises providing 450 the representation 35 of the transmission channel 30 and the one or more transmission properties 34 of the transmission channel 30 to one or more transmission success metric estimators 220, 220a, 220b, . . . , 220k. The one or more transmission success metric estimators 220, 220a, 220b, . . . , 220k are advantageously fully connected neural networks.

The method 400 further comprises obtaining 460 one or more respective estimated transmission success metrics 37, 37a, 37n, . . . , 37k from each one of the one or more transmission success metric estimators 220, 220a, 220b, . . . , 220k.

As previously indicated, the methods 300, 400 presented with reference to FIGS. 5 and 6 may be performed by, or caused by, the systems 100, 200 presented with reference to FIGS. 3a-b and 4a-b. Further to this, the methods may, wholly or partly, be performed by, or caused by, the communications network 1 presented with reference to FIG. 1. The communications network 1 may be a physical communications network 1 or a digital twin. It should be mentioned that also the channel representation provisioning system 100 and the transmission success metric estimating system 200 according to any embodiments or examples, may be implemented in either physical systems 100, 200 or in digital twins.

In FIG. 7, a schematic view of a communications network 1 is shown. The communications network may be any communications network 1 presented herein and in this embodiment, the communications network 1 comprises the channel representation provisioning system 100 as presented herein according to any embodiments or examples.

In FIG. 7, a schematic view of a communications network 1 is shown. The communications network may be any communications network 1 presented herein and in this embodiment, the communications network 1 comprises the transmission success metric estimating system 200 as presented herein according to any embodiments or examples.

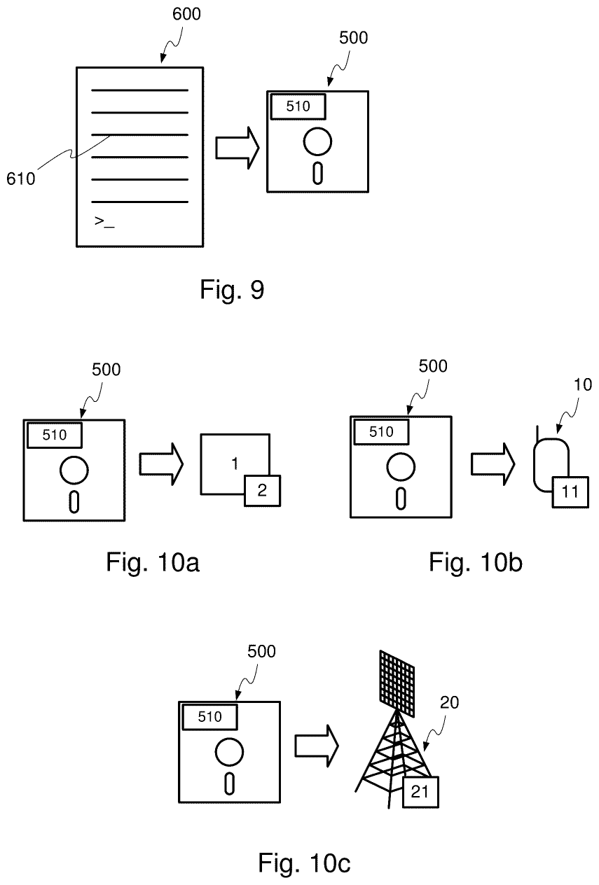

In FIG. 8, a computer program product 500 is shown. The computer program producer 500 comprises a non-transitory computer readable medium 510 such as, for example, a universal serial bus (USB) memory, a plug-in card, an embedded drive, or a read only memory (ROM). FIG. 8 illustrates an example computer readable medium 510 in the form of a vintage 5,25″ floppy disc. The computer readable medium 510 has stored thereon a computer program 600 comprising program instructions 610. The computer program 600 is loadable into a data processor, which may, for example, be a data processor 2 (see FIG. 9a) comprised in the communications network 1, a data processor 11 (see FIG. 9b) comprised in the wireless device 10, or a data processor 21 (see FIG. 9c) comprised in the radio base station 20. When loaded into the data processor 2, 11, 21, the computer program 600 may be stored in a memory associated with, or comprised in, the data processor 2, 11, 21. According to some embodiments, the computer program 600 may, when loaded into, and run by, the data processor 2, 11, 21, cause execution of method steps according to, for example, any of the methods illustrated in FIGS. 5 and 6, or otherwise described herein.

Modifications and other variants of the described embodiments will come to mind to one skilled in the art having benefit of the teachings presented in the foregoing description and associated drawings. Therefore, it is to be understood that the embodiments are not limited to the specific example embodiments described in this disclosure and that modifications and other variants are intended to be included within the scope of this disclosure. For example, while embodiments of the invention have been described with reference modelling and estimating signaling properties in a communications network, persons skilled in the art will appreciate that the embodiments of the invention can equivalently be applied to other complex models wherein it is feasible to split a set of input parameters and process them in parallel. Furthermore, although specific terms may be employed herein, they are used in a generic and descriptive sense only and not for purposes of limitation. Therefore, a person skilled in the art would recognize numerous variations to the described embodiments that would still fall within the scope of the appended claims. Furthermore, although individual features may be included in different claims (or embodiments), these may possibly advantageously be combined, and the inclusion of different claims (or embodiments) does not imply that a combination of features is not feasible and/or advantageous. In addition, singular references do not exclude a plurality. Finally, reference signs in the claims are provided merely as a clarifying example and should not be construed as limiting the scope of the claims in any way.

1. A method of providing a representation of a transmission channel in a wireless communications network, the method comprising:
obtaining a set of input propagation properties for the transmission channel;
splitting the set of input propagation properties into a plurality of input propagation property subsets;
providing each of the input propagation property subsets as input to a respective modelling circuit, wherein all respective modelling circuits are identical;
obtaining, from the respective modelling circuit, a plurality of representation subsets; and
aggregating the plurality of representation subsets, thereby providing the representation of the transmission channel.

2. The method of claim 1, wherein the plurality of input propagation property subsets comprises a first propagation property subset and a second propagation property subset, wherein the first subset of propagation properties are properties of one or more serving propagation paths of the transmission channel, and the second subset of properties are properties of one or more interfering propagation paths of the transmission channel.

3. The method of claim 1, wherein the plurality of input propagation property subsets comprises a first propagation property subset comprising properties of one or more serving propagation paths of the transmission channel and a plurality of second sets of propagation properties.

4. The method of claim 3, wherein each second set of input propagation properties are input propagation properties of interfering propagation paths of the transmission channel of a respective base station of the wireless communications network.

5. The method of claim 1, wherein aggregating the plurality of representation subsets further comprises appending one or more transmission properties to some or all of the plurality of representation subsets.

6. The method of claim 5, wherein the transmission properties comprises one or more of a transmission power and/or a master coding scheme, MCS, selection.

7. The method of claim 1, wherein the modelling circuits are neural networks, preferably LSTM-based recurrent neural networks.

8. The method of claim 7, wherein the neural networks are weight sharing neural networks.

9. A method of estimating a transmission success metric of a transmission on a transmission channel, the method comprising:
obtaining a set of input propagation properties of the transmission channel;
obtaining one or more transmission properties of the transmission channel;
providing the set of input propagation properties to the method according to claim 1, thereby obtaining a representation of the transmission channel;
providing the representation of the transmission channel and the one or more transmission properties of the transmission channel to one or more transmission success metric estimators, the one or more transmission success metric estimators being a fully connected neural network; and
obtaining, from the one or more transmission success metric estimators, one or more estimated transmission success metric.

10. The method of claim 9, wherein the estimated transmission success metric comprises an estimated transmission success rate.

11. The method of claim 9, wherein the estimated transmission success metric comprises an estimated bit error rate, BER.

12. The method of claim 9, wherein the one or more transmission properties comprises a transmission power and/or a master coding scheme, MCS, selection.

13. A channel representation provisioning system for providing a representation of a transmission channel, the channel representation provisioning system comprising:
a resolver circuit configured to obtain a set of input propagation properties for the transmission channel and split the set of input propagation properties into a plurality of input propagation property subsets;
a plurality of modelling circuits, each configured to obtain a respective input propagation property subsets, identical and provide a respective representation subsets, wherein all modelling circuits are equal; and
an aggregation circuit configured to aggregate the plurality of representation subsets and provide the representation of the transmission channel.

14. The channel representation provisioning system of claim 13, further configured to perform operations comprising:
obtain a set of input propagation properties for the transmission channel;
split the set of input propagation properties into a plurality of input propagation property subsets;
provide each of the input propagation property subsets as input to a respective modelling circuit, wherein all respective modelling circuits are identical;
obtain, from the respective modelling circuit, a plurality of representation subsets; and
aggregate the plurality of representation subsets, thereby providing the representation of the transmission channel.

15. A transmission success metric estimating system for estimating a transmission success metric of a transmission on a transmission channel, the transmission success metric estimating system comprising:
a channel representation provisioning system according to claim 13 and
one or more transmission success metric estimators configured to obtain the representation of the transmission channel from the channel representation provisioning system and provide one or more estimated transmission success metric based on one or more transmission properties and the one or more estimated transmission success metric.

16. The transmission success metric estimating system further configured to perform the method of claim 10.

17. The transmission success metric estimating system of claim 15, wherein the transmission success metric estimating system is included in a communications network.

18. The transmission success metric estimating system of claim 17, wherein the communications network is a physical wireless communications network.

19. The transmission success metric estimating system of claim 17, wherein the communications network is a digital twin of a physical wireless communications network.

20. (canceled)

21. (canceled)

22. The channel representation provisioning system of claim 14, wherein the plurality of input propagation property subsets comprises a first propagation property subset and a second propagation property subset, wherein the first subset of propagation properties are properties of one or more serving propagation paths of the transmission channel, and the second subset of properties are properties of one or more interfering propagation paths of the transmission channel.
